(19) United States
(12) Patent Application Publication
(10) Pub. No.: US 2007/0021914 A1
(43) Pub. Date: Jan. 25, 2007

(54) NAVIGATION SYSTEM WITH FUNCTION OF DESTINATION SEARCH USING SYNCHRONIZATION SERVICE OF HOME TELEMATICS SYSTEM, AND METHOD THEREOF

(76) Inventor: Kyeong Sub SONG, Icheon-shi (KR)

Correspondence Address: IPLA P.A., 3580 WILSHIRE BLVD., 17TH FLOOR, LOS ANGELES, CA, 90010, US

(21) Appl. No.: 11/424,865

(22) Filed: Jun. 17, 2006

(30) Foreign Application Priority Data
Jul. 20, 2005 (KR) 10-2005-0065561

(51) Int. Cl. G01C 21/00

(52) U.S. Cl. 701/213

(57) ABSTRACT

Provided is a navigation system with a function of destination search using a synchronization service of a home telematics system. The navigation system includes: a map database for storing map data; a GPS (global positioning system) module for receiving each position signal from a plurality of GPS satellites, and calculating a self position; a wireless communication unit for performing a data communication with the computer; and a telematics controller for searching synchronization data stored in a computer for synchronization data having the key word, setting the searched synchronization data as the destination, searching for a path from the calculated current position to the destination, mapping the searched path to the map data, and performing a function of navigation.

### BACKGROUND OF THE INVENTION

1. Field of the Invention

The present invention relates to a home telematics system, and more particularly, to a navigation system with a function of destination search using a synchronization service of a home telematics system, and a method thereof, in which a destination can be searched and set using data stored in a personal computer, by using the synchronization service of the home telematics system.

2. Description of the Related Art

In general, a navigation system map-matches position information calculated by a global positioning system (GPS) to map data, receives destination information from a user, searches for a path to a destination by a predetermined method, matches the searched path to the map data, and performs path guidance along the path from a calculated position to the destination.

In order to be guided for the path to the destination as aforementioned, the user should select the destination according to a method provided from the navigation system. In general, a searching method for setting the destination employs a searching method for a name, a parcel number, a recently used destination or a telephone number.

In the name searching method where the destination is inputted by inputting a building name or a trade name at or around the destination, it is difficult to search for the destination in case where the user is ignorant of an exact name, and it is difficult to accurately search for his/her desiring destination and the user can be confused since the same name can be searched in plural.

In the parcel number searching method where an address of the destination is directly inputted and which can be used when the user is aware of a whole address, it is difficult to provide a user's substantial use.

In the telephone number searching method where the navigation system has a database corresponding to a telephone book provided from a telephone office, and the user inputs the telephone number, searches for an address corresponding to the inputted telephone number, and sets the searched address as the destination, there is an advantage in that the destination can be searched even when the user knows only the telephone number. However, there is a disadvantage in that the telephone number searching method cannot be used for a telephone number not registered to the database.

In the recently used destination searching method where the user records information on the recently used destinations and again sets the recorded information as the destination, the exact destination most desired can be provided on an aspect of the user. However, the recently used destination searching method has a limitation in number of the recorded destination, and other searching methods should be employed for searching a new destination.

As described above, the conventional searching methods for setting the destination have merits and demerits, respectively and therefore, have a drawback in that the user should select and use the relatively exact destination searching method from the searching methods and, even though the relatively easy searching method is selected and used, it is difficult to search for the exact destination.

Accordingly, various methods for more exactly searching for the user's desiring destination are being required on the aspect of the user.

### SUMMARY OF THE INVENTION

Accordingly, the present invention is directed to a navigation system with a function of destination search using a synchronization service of a home telematics system and a method thereof that substantially overcome one or more of the limitations and disadvantages of the conventional art.

One object of the present invention is to provide a navigation system with a function of destination search using a synchronization service of a home telematics system, and a method thereof, in which a destination can be searched and set using data stored in a personal computer, by using the synchronization service of the home telematics system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a navigation system with a function of destination search using a synchronization service of a home telematics system, the navigation system being capable of remotely using synchronization data that is stored in a computer and has an address and a telephone number, the system including: a map database for storing map data; a GPS (global positioning system) module for receiving each position signal from a plurality of GPS satellites, and calculating a self position; a wireless communication unit for performing a data communication with the computer through the home telematics system under a predetermined control; and a telematics controller for, upon receipt of a key word for a destination from a user, searching the synchronization data stored in the computer for synchronization data having the key word, setting the searched synchronization data as the destination, searching for a path from the calculated current position to the destination, mapping the searched path to the map data, and performing a function of navigation.

In another aspect of the present invention, there is provided a method of destination search in a navigation system with a function of destination search using a synchronization service of a home telematics system, the navigation system being capable of remotely using synchronization data that is stored in a computer and has an address and a telephone number, the method including the steps of: upon receipt of a key word for a destination, transmitting a search request message having the key word to the computer through the home telematics system; and upon receipt of the synchronization data having the key word in response to the search request message, detecting the address from the synchronization data, setting the detected address as the destination, searching for a path from a current position to the destination, and performing a function of navigation.

In a further another aspect of the present invention, there is provided a method of destination search in a navigation system with a function of destination search using a synchronization service of a home telematics system, the navigation system being capable of remotely using synchronization data that is stored in a computer and has an address and a telephone number, the method including the steps of: upon receipt of a key word for a destination, transmitting a message of requesting the synchronization data to the computer through the home telematics system; upon receipt of the synchronization data in response to the synchronization data request message, storing the received synchronization data; searching the stored synchronization data for synchronization data having the key word; and detecting the address from the synchronization data, setting the detected address as the destination, searching for a path from a current position to the destination, and performing a function of navigation.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a home telematics system according to the present invention;

FIG. 2 illustrates a first synchronization method of a home telematics system according to the present invention;

FIG. 3 illustrates a second synchronization method of a home telematics system according to the present invention;

FIG. 4 illustrates a construction of a telematics terminal including a navigation system according to the present invention;

FIG. 5 is a flowchart illustrating a method of destination search using a synchronization service of a home telematics system according to the first embodiment of the present invention; and

FIG. 6 is a flowchart illustrating a method of destination search using a synchronization service of a home telematics system according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

On the basis of invention disclosed in Korean Patent Application No. 1020050065546 entitled “HOME TELEMATICS SYSTEM PROVIDING SYNCHRONIZATION SERVICE BETWEEN TELEMATICS TERMINAL AND COMPUTER AND METHOD THEREOF” filed on Jul. 20, 2005 in the name of this applicant, the present invention searches for a destination, searches for a path from a current position to the searched destination, and performs path guidance. In detail, the invention of the Korean Patent Application No. 1020050065546 provides a synchronization service between a telematics terminal and a computer for storing synchronization data, such as information on drive courses, information on restaurants including telephone numbers and addresses directly recorded by a user, and information on a friend, a relative, and a customer including telephone numbers and addresses, thereby allowing even the telematics terminal to use the stored synchronization data of the computer.

Hereinafter, a navigation system with a function of destination search using a synchronization service of a home telematics system, and a method thereof will be described with reference to the drawings.

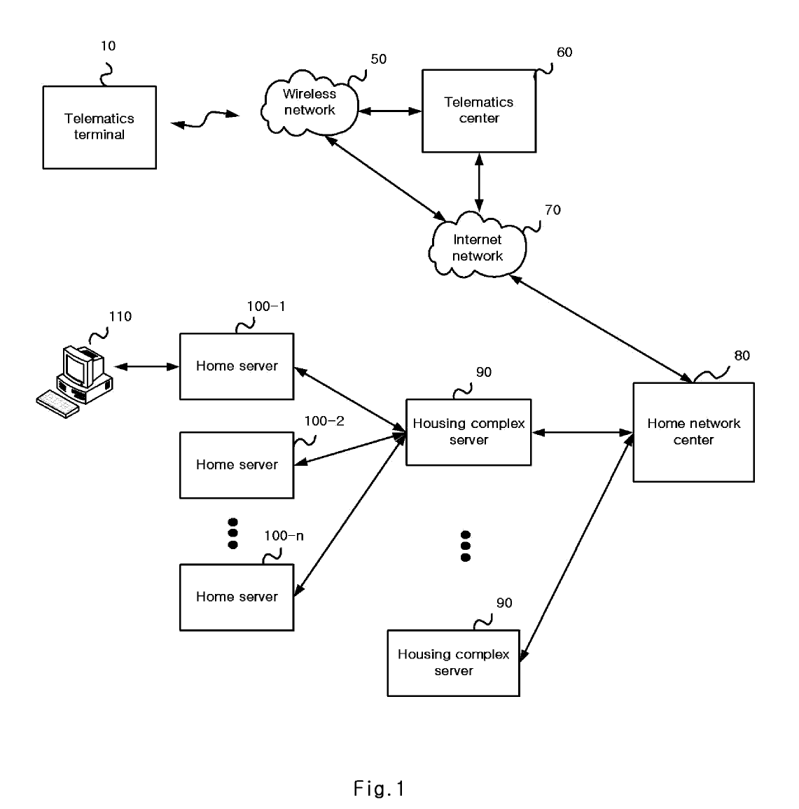

FIG. 1 illustrates a construction of the home telematics system according to the present invention. A description will be made with reference to FIG. 1 below.

The home telematics system includes a telematics system and a home network system. The telematics system includes a telematics terminal 10, a wireless network 50, a telematics center 60, and an Internet network 70. The home network system includes the wireless network 50, the Internet network 70, a home network center 80, a housing complex server 90, a home server 100, and home terminal devices. The terminal device can be controlled or can perform a data communication under the control of the home server 100. The terminal device can be a gas valve on/off device, a door lock device, an illuminator, an air conditioner/heater, a videophone, and a computer. Hereinafter, it should be noted that a description will be made only for a case where the terminal device is the computer since the inventive terminal device refers to the computer.

The inventive home telematics system includes the telematics terminal 10, the wireless network 50, the telematics center 60, the Internet network 70, the home network center 80, the housing complex server 90, the home server 100, and the computer 110 being the home terminal device.

The telematics terminal 10 receives various telematics services such as an emergency rescue service, an e-mail service, a news and weather service. Further, the telematics terminal 10 has information on its own home server 100-1, for example, Internet protocol (IP) information. Upon request for a home telematics service, the telematics terminal 10 connects to the home network center 80 through the wireless network 50 and the Internet network 70, and controls the home terminal devices or performs the data communication with the computer 110 through the corresponding housing complex server 90 and the corresponding home server 100, via the home network center 80. Further, the telematics terminal 10 includes a GPS module and a map database (DB) to periodically calculate a self position, map-match the calculated position to map data, and display the map-matched position, and includes the navigation system for receiving a destination from the user and searching for the path according to a predetermined method.

The telematics center 60 provides the various telematics services to a plurality of the telematics terminals 10, and manages authentication and billing for the services. Further, upon generation of a request for controlling the home terminal devices or performing the data communication from the predetermined telematics terminal 10, the telematics center 60 requests the home network center 80 for the authentication in order to control the home terminal devices or perform the data communication and, upon authentication success, connects the home network center 80 with the corresponding telematics terminal 10.

The home network center 80 manages authentication and access information on a plurality of the housing complex servers 90 and the home servers 100, performs the authentication according to a telematics center's request for authentication on the predetermined telematics terminal 10 and, upon the authentication success, connects with the corresponding home server 100.

The home server 100 has synchronization object information on the home terminal devices, that is, information on the computer, the illuminator, and the air conditioner/heater. The home server 100 determines whether or not a reception signal is for any terminal device, and controls the corresponding terminal device or transmits data to the corresponding terminal device. Further, the home server 100 collects and transmits state information on the terminal devices to the telematics terminal 10.

The computer 110 has a control program for synchronizing data with the telematics terminal 10. The computer 110 stores information on a restaurant, a historic site, and a tourist destination including a telephone number and an address book, and data such as an address book having a telephone number and an address for a friend, a relative, and a customer (Hereinafter, referred to as “synchronization data”) in a previously allocated storage region, and shares the synchronization data with the telematics terminal 10 through the corresponding home server 100, the housing complex server 90, the home network center 80, the Internet network 70, and the wireless network 50, only for the allocated storage region (Hereinafter, referred to as “synchronization data allocation storage region”). The computer 110 can be a personal computer (PC), a notebook, or a personal digital assistant (PDA).

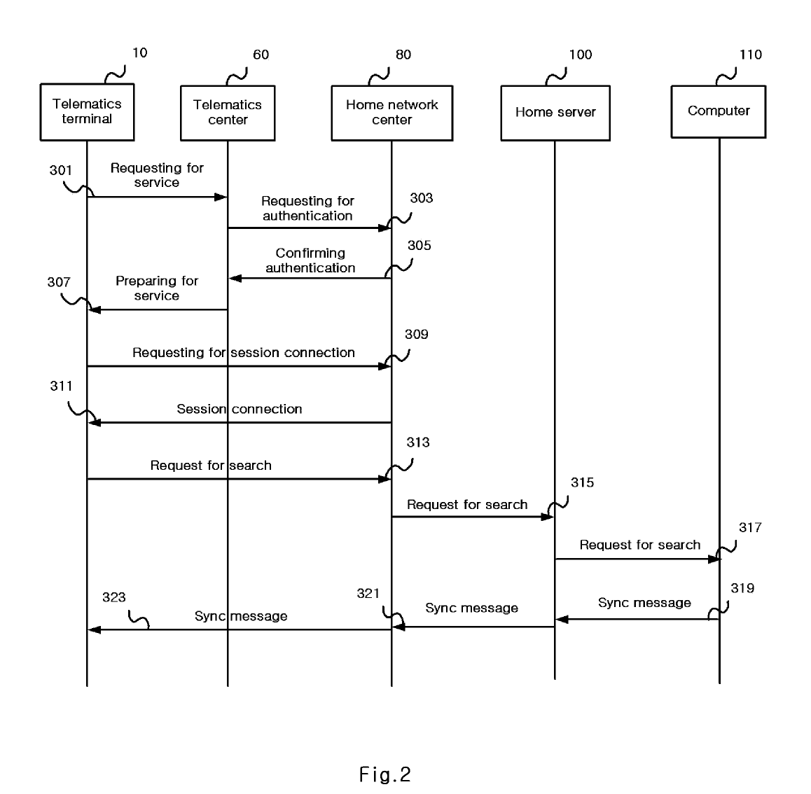

FIG. 2 illustrates a first synchronization method of a home telematics system according to the present invention. Hereinafter, the synchronization service method will be described with reference to FIGS. 1 and 2.

Upon generation of a home telematics service request from a user, in Step 301, the telematics terminal 10 transmits a service request message including self identification and authentication information, destination (home server 100-1) information, and message kind information, to the telematics center 60. The authentication information includes first authentication information on the telematics center 60, second authentication information on the home network center 80, and third authentication information for performing the authentication in the computer 110 being the terminal device.

Upon receipt of the service request message from the telematics terminal 10, in Step 303, the telematics center 60 transmits an authentication request message of requesting the authentication on the telematics terminal 60, to the home network center 80. The authentication request message includes telematics terminal 10 information, destination information, and authentication information on the telematics terminal 10.

Upon receipt of the authentication request message, the home network center 80 detects the destination information and the authentication information from the received authentication request message, compares the detected authentication information with previously stored authentication information on a destination, performs the authentication, and transmits an authentication confirmation message including authentication result information to the telematics center 60 in Step 305.

If so, the telematics center 60 analyzes the authentication confirmation message and, upon authentication success, in Step 307, transmits a service preparation message of informing that preparation for service is completed to the telematics terminal 10.

In Step 309, the telematics terminal 10 receives the service preparation message, and transmits a session connection request message of requesting a session connection, which sets, maintains, and synchronizes mutual communication between communication systems, to the home network center 80 through the wireless network 50 or through the wireless network 50 and the telematics center 60.

In Step 311, the home network center 80 receives the session connection request message, and transmits a session connection message of permitting the session connection with the corresponding home server 100-1, to the telematics terminal 10.

If the session connection between the telematics terminal 10 and the home server 100-1 is performed, in Step 313, the telematics terminal 10 transmits a search request message having self identification information, third authentication information, key word and destination information, final terminal device (computer 110) information, and message kind information, to the home network center 80. According to the present invention, the key word is a key word for the destination for which the user intends to search.

The home network center 80 receives the search request message, detects and analyzes the destination information of the search request message, and transmits the search request message to the home server 100-1 corresponding to the destination information in Step 315.

The home server 100-1 receives the search request message, detects and analyzes terminal device (computer 110) information from the search request message, and transmits the terminal device information to a corresponding terminal device, that is, to the computer 110.

The computer 110 receives the search request message, detects the third authentication information from the search request message, and performs authentication. Upon authentication success, the computer 110 detects the key word from the search request message, and searches stored synchronization data of the synchronization data allocation storage region for synchronization data having the key word. Upon authentication failure, the computer 110 transmits a synchronization message including authentication failure data to the home server 100-1 in Step 319. If the synchronization data having the keyword is searched, in Step 319, the computer 110 generates and transmits the synchronization message to the home server 100-1 and, otherwise, transmits a synchronization message including search failure data to the home server 100-1.

The home server 100 receives the synchronization message, and transmits the received synchronization message to the home network center 80 in Step 321, and the home network center 80 transmits the synchronization message to the telematics terminal 10 in Step 323.

The telematics terminal 10 receives the synchronization message, detects the synchronization data, the authentication failure data, or the search failure data from the synchronization message, and displays the detected data on a liquid crystal display (LCD). If the synchronization message is the synchronization data according to the present invention, address information is detected from the synchronization data, a position corresponding to the detected address is set as the destination, the path from the current position to the destination is searched, the searched path is matched to the map data, and the matched path is displayed.

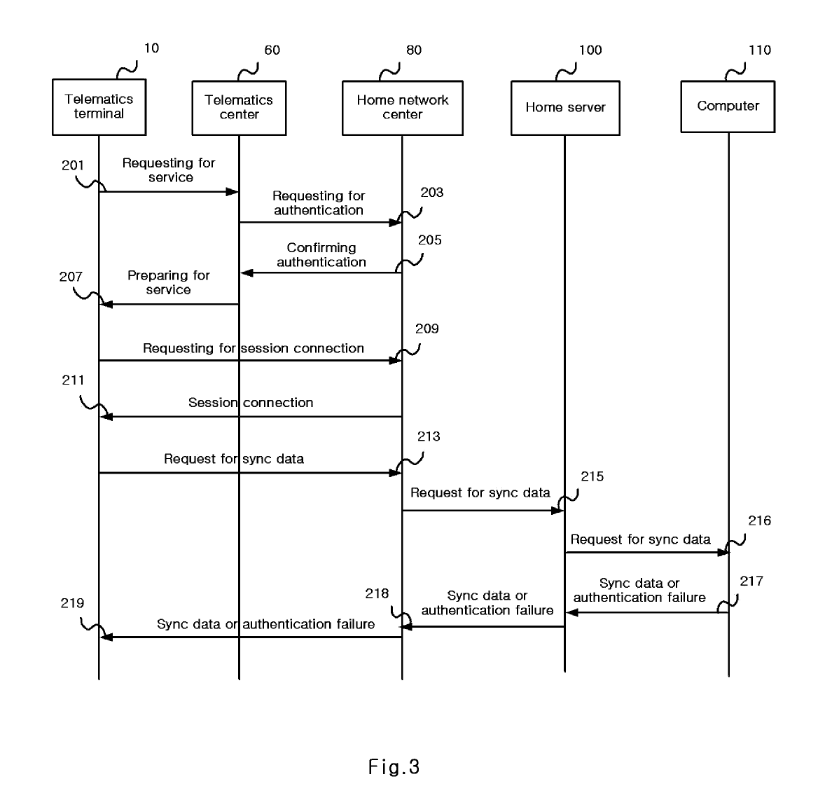

FIG. 3 illustrates a second synchronization method of a home telematics system according to the present invention.

Referring to FIG. 3, even in FIG. 3, session connection between the telematics terminal 10 and the home server 100-1 is performed through Steps 201 to 211 in the same manner as up to the Step 311 of FIG. 2.

Upon receipt of the session connection message from the home network center 80, in Step 213, the telematics terminal 10 transmits a synchronization data request message including self identification and authentication information, destination (home server 100-1) information, and message kind information, to the home network center 80. The authentication information is the third authentication information for performing the authentication in the computer 110.

In Step 215, the home network center 80 transmits the synchronization data request message to the corresponding home server 100-1 and, in Step 216, the home server 100-1 transmits the received data request message to the computer 110.

Upon receipt of the synchronization data request message from the home server 100-1, the computer 110 detects and compares the third authentication information with previously stored authentication information, performs the authentication, and transmits a synchronization message to the home server 100-1 according to a home network protocol in Step 217. Upon the authentication success, the synchronization message includes synchronization data and, upon the authentication failure, the synchronization message includes authentication failure data for informing the authentication failure.

The home server 100-1 receives the synchronization message, transmits the received synchronization message to the home network center 80 in Step 218, and transmits the synchronization message to the telematics terminal 10 in Step 219.

The telematics terminal 10 receives the synchronization message, detects the synchronization data or the authentication failure data from the synchronization message, and displays the detected data on a display device for notification.

In FIGS. 2 and 3, a system operation is described. Hereinafter, a construction and an operation of the telematics terminal 10 including the navigation system will be described.

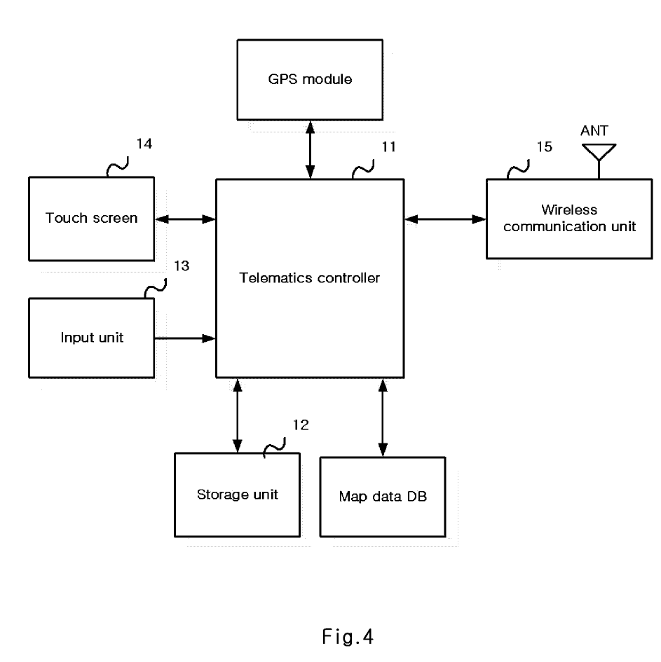

FIG. 4 schematically illustrates the construction of the telematics terminal 10 including the navigation system according to the present invention.

Referring to FIG. 4, the inventive telematics terminal 10 includes a controller 11, a storage unit 12, an input unit 13, a touch screen 14, a wireless communication unit 15, a map database (DB) 16, and a GPS module 17.

The telematics controller 11 controls a general operation of the telematics terminal 10, including an operation of the navigation system according to the present invention.

The storage unit 12 includes a region for storing a control program controlling the operation of the telematics terminal 10; a region for temporarily storing data generated in execution of the control program, and a region for storing the synchronization data.

The input unit 13 employs the key input unit including a plurality of keys such as a mode key, a search key, an end key, and a selection key, and generates and outputs key data on the keys to the telematics controller 11. At this time, the telematics controller 11 performs an operation corresponding to the key data.

The touch screen 14 is integrated with a display device such as the LCD, and generates a coordinate value for a pressed portion and outputs the generated coordinate value to the telematics controller 11. At this time, the telematics controller 11 receives the coordinate value and performs an operation corresponding to the coordinate value.

Hereinafter, the key data and the coordinate data generated from the input unit 13 and the touch screen 14 are generally called “command”.

The wireless communication unit 15 wirelessly connects with the wireless network 50 of FIG. 1 through an antenna (ANT), and performs the data communication.

The map DB 16 stores the map data based on latitude and longitude.

The GPS module 17 includes a gyroscope, and receives the respective position signals from a plurality of GPS satellites through a satellite antenna (not shown), calculates the self position from the position signals, and outputs the calculated self position, together with direction information measured by the gyroscope, to the telematics controller 11. At this time, the telematics controller 11 map-matches the calculated position to a corresponding position of the map data, includes the direction information in the map data, and displays the map data on the touch screen.

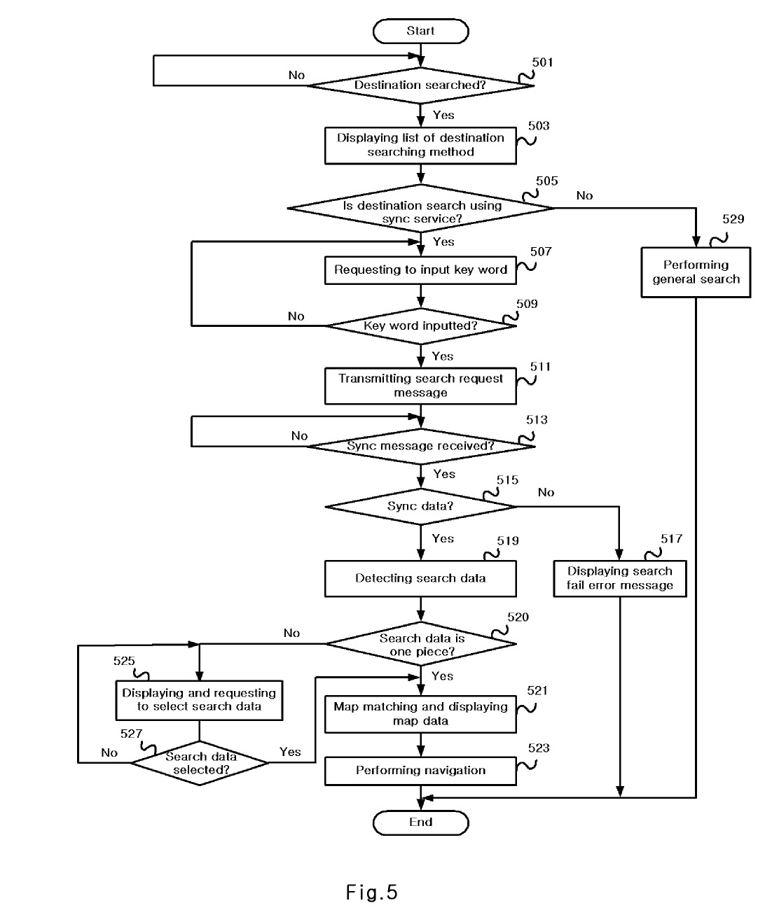

FIG. 5 is a flowchart illustrating a method of destination search using the synchronization service of the home telematics system according to the first embodiment of the present invention. A description will be made with reference to FIGS. 4 and 5 below.

In Step 501, the telematics controller 11 determines whether or not to receive a destination search command from the input unit 13 or the touch screen 14.

Upon receipt of the destination search command in the Step 501, in Step 503, the telematics controller 11 displays destination searching methods, that is, a list of searching methods of such as a name, an address, a recently used destination, and a synchronization service destination according to the present invention, and requests to select the destination searching method.

After the Step 503, in Step 505, the telematics controller 11 determines whether or not to select a synchronization service destination searching method.

If it is determined in the Step 505 to select a destination searching method other than the synchronization service destination searching method, in Step 529, the telematics controller 11 performs a general search function and terminates. If it is determined to select the synchronization service destination searching method according to the present invention, Step 507 is performed. Instead of the Steps 503 and 505, the input unit 13 or the touch screen 14 includes a separate key or button for the synchronization service destination search, and the Step 507 can be also performed by the key or button pressed.

In the Step 507, the telematics controller 11 displays a window for requesting to input a key word through the touch screen 14.

After the Step 507, in Step 509, the telematics controller 11 determines whether or not to receive the key word. Upon receipt of the key word, in Step 511, the telematics controller 11 generates a search request message including the key word and transmits the generated message through the wireless communication unit 15.

After the transmitting of the search request message, in Step 513, the telematics controller 11 determines whether or not to receive a synchronization message through the wireless communication unit 15. Upon receipt of the synchronization message, in Step 515, the telematics controller 11 determines whether data included in the synchronization message is synchronization data or error data. If it is determined to be the error data, in Step 517, the telematics controller 11 displays a search failure error message on the touch screen 14. If it is determined to be the synchronization data, that is, search data, in Step 519, the telematics controller 11 detects the search data. Upon detection of the search data, in Step 520, the telematics controller 11 determines whether or not the search data is one piece.

If the search data is determined to be one piece, in Step 521, the telematics controller 11 detects position information, that is, address of the search data, sets the detected address as the destination, searches for the path from the current position calculated in the GPS module 17 to the destination of the address, and matches and displays the searched path to the map data. In Step 523, a function of navigation is performed.

On the contrary, if the search data is determined to be two pieces, in Step 525, the telematics controller 11 displays the search data and requests to select one piece from the search data.

After the Step 525, in Step 527, the telematics controller 11 determines whether or not to select one piece from the search data. Upon the selecting of one piece from the search data in the Step 527, the Steps 521 and 523 are performed.

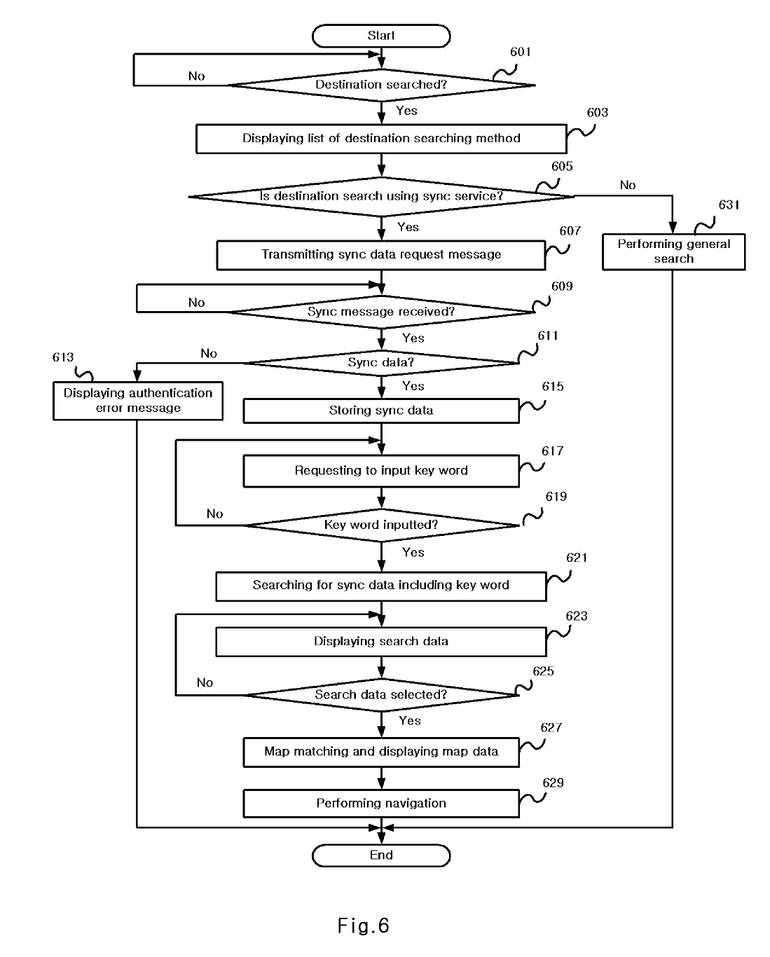

FIG. 6 is a flowchart illustrating a method of destination search using a synchronization service of a home telematics system according to the second embodiment of the present invention. A description will be made with reference to FIGS. 4 and 6.

Upon receipt of a command for the destination search, in the same Steps 601, 603, and 605 as the Steps 501, 503, and 505, a telematics controller 11 displays a destination searching method list, and determines whether or not to select a synchronization service destination searching method from destination searching methods of the list.

Upon the selecting of the synchronization service destination search, in Step 607, the telematics controller 11 transmits a message of requesting synchronization data, through a wireless communication unit 15.

After the transmitting of the synchronization data request message, in Step 609, the telematics controller 11 determines whether or not to receive a synchronization message. Upon receipt of the synchronization message in the Step 609, the telematics controller 11 determines whether the synchronization message has synchronization data or authentication error data.

If the synchronization message has the authentication error data, in Step 613, the telematics controller 11 displays an authentication error message on the touch screen 14. If the synchronization message has the synchronization data, in Step 615, the telematics controller 11 stores the synchronization data in a storage unit 12.

After the storing of the synchronization data, in Step 617, the telematics controller 11 displays a window for requesting to input a key word, on the touch screen 14, and in Step 619, determines whether or not to receive the key word.

Upon receipt of the key word in the Step 619, in Step 621, the telematics controller 11 searches the synchronization data for synchronization data including the key word and, in Step 629, displays the searched synchronization data. If there is not the searched synchronization data, a search failure message is displayed and Step 627 is performed. If the searched data is one piece as shown in FIG. 5, the Step 627 can be also directly performed.

In the Step 627, the telematics controller 11 detects an address of the searched synchronization data, sets the detected address as the destination, searches a path from an outputted current position of a GPS module 17 to the set destination, matches the searched path to map data, and displays the matched path on the touch screen 14. In Step 629, a function of navigation is performed.

In FIG. 6, the synchronization data is received through the synchronization process, the key word is received, and the search is performed. However, a process can be also performed in a sequence that the key word is received, the synchronization data is received, and the key word is searched.

As described above, the present invention has an advantage in that the user can easily search his/her desiring destination on the aspect of the user since the destination is searched and set, using the data on the restaurant, the tourist destination, the friend, the relative, and the customer including the telephone number and/or the address directly inputted through the personal computer by the user.

Further, the present invention has an advantage in that various destination search means can be provided to the user since a new destination search means is provided.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A navigation system with a function of destination search using a synchronization service of a home telematics system, the navigation system being capable of remotely using synchronization data that is stored in a computer and has an address and a telephone number, the system comprising:
a map database for storing map data;
a GPS (global positioning system) module for receiving each position signal from a plurality of GPS satellites, and calculating a self position;
a wireless communication unit for performing a data communication with the computer through the home telematics system under a predetermined control; and
a telematics controller for, upon receipt of a key word for a destination from a user, searching the synchronization data stored in the computer for synchronization data having the key word, setting the searched synchronization data as the destination, searching for a path from the calculated current position to the destination, mapping the searched path to the map data, and performing a function of navigation.

2. The system according to claim 1, wherein the telematics controller transmits a search request message having the key word, receives the synchronization data in response to the search request message, and sets the received synchronization data as the destination.

3. The system according to claim 1, wherein, upon receipt of the keyword, the telematics controller transmits a message of requesting the synchronization data, receives the synchronization data in response to the synchronization data request message, searches the received synchronization data for the synchronization data having the key word, and sets the searched synchronization data as the destination.

4. A method of destination search in a navigation system with a function of destination search using a synchronization service of a home telematics system, the navigation system being capable of remotely using synchronization data that is stored in a computer and has an address and a telephone number, the method comprising the steps of:
upon receipt of a key word for a destination, transmitting a search request message having the key word to the computer through the home telematics system; and
upon receipt of the synchronization data having the key word in response to the search request message, detecting the address from the synchronization data, setting the detected address as the destination, searching for a path from a current position to the destination, and performing a function of navigation.

5. The method according to claim 4, further comprising the steps of, if the synchronization data is two pieces or more, displaying the synchronization data, determining whether or not to select one piece from the synchronization data by a user, detecting the address of the selected synchronization data, and setting the detected address as the destination.

6. A method of destination search in a navigation system with a function of destination search using a synchronization service of a home telematics system, the navigation system being capable of remotely using synchronization data that is stored in a computer and has an address and a telephone number, the method comprising the steps of:
upon receipt of a key word for a destination, transmitting a message of requesting the synchronization data to the computer through the home telematics system;
upon receipt of the synchronization data in response to the synchronization data request message, storing the received synchronization data;
searching the stored synchronization data for synchronization data having the key word; and
detecting the address from the synchronization data, setting the detected address as the destination, searching for a path from a current position to the destination, and performing a function of navigation.

7. The method according to claim 6, further comprising the steps of, if the synchronization data is two pieces or more, displaying the synchronization data, determining whether or not to select one piece from the synchronization data by a user, detecting the address of the selected synchronization data, and setting the detected address as the destination.
